(19) United States
(12) Patent Application Publication
(10) Pub. No.: US 2026/0209410 A1
(43) Pub. Date: Jul. 23, 2026

(54) PROCESS FOR PRODUCING A POLYPROPYLENE COPOLYMER

(71) Applicant: BOREALIS AG, Vienna (AT)

(72) Inventors: Jingbo WANG, Linz (AT); Markus GAHLEITNER, Linz (AT); Klaus BERNREITNER, Linz (AT); Pauli LESKINEN, Porvoo (FI); Jani AHO, Porvoo (FI); Ville VIRKKUNEN, Porvoo (FI); Joana Elvira KETTNER, Linz (AT)

(73) Assignee: BOREALIS AG, Vienna (AT)

(21) Appl. No.: 19/141,998

(22) PCT Filed: Dec. 18, 2023
(86) PCT No.: PCT/EP2023/086302

§ 371 Date: Jun. 20, 2025

(30) Foreign Application Priority Data
Dec. 23, 2022 (EP) 22216280.2

(51) Int. Cl. C08F 210/16

(52) U.S. Cl. CPC C08F 210/16

(57) ABSTRACT

The present application relates to a process for the production of a polypropylene copolymer, the process comprising the steps of a) prepolymerising propylene in a first reactor in the presence of ethylene and a metallocene catalyst yielding a prepolymer, wherein a ratio of the feed of ethylene to the feed of propylene is in the range of 0.1 to 15 mol/kmol, b) transferring the prepolymer to a second reactor, c) polymerising propylene in the second reactor in the presence of said prepolymer, one or more comonomers selected from alpha olefins having from 2 or 4 to 10 carbon atoms or mixtures thereof, preferably 2 or 4 carbon atoms, yielding a polypropylene copolymer, d) withdrawing the polypropylene copolymer from the second reactor or transferring the polypropylene copolymer to a third reactor, wherein the metallocene catalyst comprises a metallocene complex and a support, wherein the support comprises silica.

The present invention is concerned with a process for producing a polypropylene copolymer with defined feed ratio of ethylene to propylene in the presence of a metallocene catalyst.

### BACKGROUND

Polypropylene based copolymers like propylene-ethylene copolymers are a group of interesting materials for a wide usage in different applications, which require a combination of good cost/performance ratio. The properties of the propylene copolymers also depend on the morphology of the catalyst used in the polymerization process.

Therefore, there is a general interest control the powder morphology in polymerisation processes of such polypropylene copolymers. In polypropylene polymerisation processes known in the prior art, the original morphology of the catalyst and how to start the catalyst are crucial for the final polymer powder morphology. A non-ideal start could lead to non-ideal final polymer powder morphology.

Consequently, in order to avoid the abrupt change of the environment for the catalyst and to avoid an initial overreaction, a prepolymerization step respectively a prepolymerization reactor is normally installed before the major polymerization reactor. In the prepolymerization the catalyst is started with moderate conditions so as to retain the morphology. This step has an effect on the final morphology of the catalyst. The moderate conditions are catalyst- and process-specific.

It is also known that the morphology of the polymer particle is determined by the shape of the supported catalyst particle by the so-called replica effect.

Therefore, there is the constant need for further improving the polymerisation processes of polypropylene in view of maintaining a good polymer powder morphology and in particular a defined bulk density.

### OBJECT OF THE PRESENT INVENTION

It is therefore an object of the present invention to provide a process for the polymerisation of propylene which overcomes the problems mentioned above.

It is a further object of the present invention to provide a process for the polymerisation of propylene and maintaining and preferably improving, the polymer powder morphology.

### Definitions

The term ‘copolymer of [monomer]’ as used herein denotes a polymer where the majority by weight of which derives from the [monomer] units (i.e. at least 50 wt. % [monomer] relative to the total weight of the copolymer).

### SUMMARY OF THE INVENTION

It now has been surprisingly found that above-mentioned object can be achieved by a process for the production of a polypropylene copolymer, the process comprising the steps of
a) prepolymerising propylene in a first reactor in the presence of ethylene and a metallocene catalyst yielding a prepolymer, wherein a ratio of the feed of ethylene to the feed of propylene is in the range of 0.1 to 15 mol/kmol,
b) transferring the prepolymer to a second reactor,
c) polymerising propylene in the second reactor in the presence of said prepolymer and one or more comonomers selected from alpha olefins having from 2 or 4 to 10 carbon atoms or mixtures thereof, preferably 2 or 4 carbon atoms, yielding a polypropylene copolymer,
d) withdrawing the polypropylene copolymer from the second reactor or transferring the polypropylene copolymer to a third reactor, preferably transferring the polypropylene copolymer to a third reactor,
wherein the metallocene catalyst comprises a metallocene complex and a support, wherein the support comprises silica.

The invention is based on the surprising finding that the morphology or the development of the morphology of the polymerization catalyst and the polymer powder can be improved by additionally feeding ethylene into the prepolymerization reactor.

### DETAILED DESCRIPTION OF INVENTION

The polypropylene copolymer is prepared in the presence of a metallocene catalyst, preferably of at least one metallocene catalyst. A metallocene catalyst typically comprises a metallocene/activator reaction product impregnated in a porous support at maximum internal pore volume. The metallocene complex comprises a ligand which is typically bridged, and a transition metal of group IVa to VIa, and an organoaluminium compound. The catalytic metal compound is typically a metal halide.

The metallocene catalyst according to the present invention may be any supported metallocene catalyst suitable for the production of polypropylene copolymers.

It is preferred that the metallocene catalyst comprises a metallocene complex, a co-catalyst system comprising a boron-containing co-catalyst and/or aluminoxane co-catalyst, and a support preferably a support comprising or consisting of silica.

Examples of suitable metallocene compounds are given, among others, in EP 629631, EP 629632, WO 00/26266, WO 02/002576, WO 02/002575, WO 99/12943, WO 98/40331, EP 776913, EP 1074557 and WO 99/42497, EP2402353, EP2729479 and EP2746289.

The metallocene complex is ideally an organometallic compound (C) which comprises a transition metal (M) of Group 3 to 10 of the Periodic Table (IUPAC 2007) or of an actinide or lanthanide. The term “an organometallic compound (C)” in accordance with the present invention includes any metallocene compound of a transition metal which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well lanthanides or actinides.

In an embodiment the organometallic compound (C) has the following formula (I):

(L)ₘRₙMX_{q} (1)
wherein
“M” is a transition metal (M) transition metal (M) of Group 3 to 10 of the Periodic Table (IUPAC 2007);
each “X” is independently a monoanionic ligand, such as a σ-ligand;
each “L” is independently an organic ligand which coordinates to the transition metal “M”;
“R” is a bridging group linking said organic ligands (L);
“m” is 1, 2 or 3, preferably 2;
“n” is 0, 1 or 2, preferably 1;
“q” is 1, 2 or 3, preferably 2; and
m+q is equal to the valency of the transition metal (M).
“M” is preferably selected from the group consisting of zirconium (Zr), hafnium (Hf), or titanium (Ti), more preferably selected from the group consisting of zirconium (Zr) and hafnium (Hf).

In a more preferred definition, each organic ligand (L) is independently
(a) a substituted or unsubstituted cyclopentadienyl or a bi- or multicyclic derivative of a cyclopentadienyl which optionally bear further substituents and/or one or more hetero ring atoms from a Group 13 to 16 of the Periodic Table (IUPAC); or
(b) an acyclic η¹- to η⁴- or η⁶-ligand composed of atoms from Groups 13 to 16 of the Periodic Table, and in which the open chain ligand may be fused with one or two, preferably two, aromatic or non-aromatic rings and/or bear further substituents; or
(c) a cyclic η¹- to η⁴- or η⁶-, mono-, bi- or multidentate ligand composed of unsubstituted or substituted mono-, bi- or multicyclic ring systems selected from aromatic or non-aromatic or partially saturated ring systems, such ring systems containing optionally one or more heteroatoms selected from Groups 15 and 16 of the Periodic Table.

Organometallic compounds (C), preferably used in the present invention, have at least one organic ligand (L) belonging to the group (a) above. Such organometallic compounds are called metallocenes.

More preferably at least one of the organic ligands (L), preferably both organic ligands (L), is (are) selected from the group consisting of cyclopentadienyl, indenyl, tetrahydroindenyl, fluorenyl, which can be independently substituted or unsubstituted.

Further, in case the organic ligands (L) are substituted it is preferred that at least one organic ligand (L), preferably both organic ligands (L), comprise one or more substituents independently selected from C₁ to C₂₀ hydrocarbyl or silyl groups, which optionally contain one or more heteroatoms selected from groups 14 to 16 and/or are optionally substituted by halogen atom(s),

The term C₁ to C₂₀ hydrocarbyl group, whenever used in the present application, includes C₁ to C₂₀ alkyl, C₂ to C₂₀ alkenyl, C₂ to C₂₀ alkynyl, C₃ to C₂₀ cycloalkyl, C₃ to C₂₀ cycloalkenyl, C₆ to C₂₀ aryl, C₂ to C₂₀ alkylaryl or C₂ to C₂₀ arylalkyl groups or mixtures of these groups such as cycloalkyl substituted by alkyl.

Further, two substituents, which can be same or different, attached to adjacent C-atoms of a ring of the ligands (L) can also taken together form a further mono or multicyclic ring fused to the ring.

Preferred hydrocarbyl groups are independently selected from linear or branched C₁ to C₁₀ alkyl groups, optionally interrupted by one or more heteroatoms of groups 14 to 16, like O, N or S, and substituted or unsubstituted C₆ to C₂₀ aryl groups.

Linear or branched C₁ to C₁₀ alkyl groups, optionally interrupted by one or more heteroatoms of groups 14 to 16, are more preferably selected from methyl, ethyl, propyl, isopropyl, tertbutyl, isobutyl, C₅₋₆ cycloalkyl, OR, SR, where R is C₁ to C₁₀ alkyl group,

C₆ to C₂₀ aryl groups are more preferably phenyl groups, optionally substituted with 1 or 2 C₁ to C₁₀ alkyl groups as defined above.

By “σ-ligand” is meant throughout the invention a group bonded to the transition metal (M) via a sigma bond.

Further, the ligands “X” are preferably independently selected from the group consisting of hydrogen, halogen, C₁ to C₂₀ alkyl, C₁ to C₂₀ alkoxy, C₂ to C₂₀ alkenyl, C₂ to C₂₀ alkynyl, C₃ to C₁₂ cycloalkyl, C₆ to C₂₀ aryl, C₆ to C₂₀ aryloxy, C₇ to C₂₀ arylalkyl, C₇ to C₂₀ arylalkenyl, —SR″, —Pr″₃, —SIR″₃, —OSIR″₃ and —NR″₂, wherein each R″ is independently hydrogen, C₁ to C₂₀ alkyl, C₂ to C₂₀ alkenyl, C₂ to C₂₀ alkynyl, C₃ to C₁₂ cycloalkyl or C₆ to C₂₀ aryl.

More preferably “X” ligands are selected from halogen, C₁ to C₆ alkyl, C₅ to C₆ cycloalkyl, C₁ to C₆ alkoxy, phenyl and benzyl groups.

The bridging group “R” may be a divalent bridge, preferably selected from —R′₂C—, —R′₂C—CR′₂—, —R′₂Si—, —R′₂Si—Si R′₂—, —R′₂Ge—, wherein each R′ is independently a hydrogen atom, C₁ to C₂₀ alkyl, C₂ to C₁₀ cycloalkyl, tri(C₁-C₂₀-alkyl) silyl, C₆-C₂₀-aryl, C₇-C₂₀ arylalkyl and C₇-C₂₀-alkylaryl.

More preferably the bridging group “R” is a divalent bridge selected from —R′₂C—, —R′₂Si—, wherein each R′ is independently a hydrogen atom, C₁ to C₂₀ alkyl, C₂ to C₁₀ cycloalkyl, C₆-C₂₀-aryl, C₇-C₂₀ arylalkyl and C₇-C₂₀-alkylaryl.

Another subgroup of the organometallic compounds (C) of formula (I) is known as non-metallocenes wherein the transition metal (M), preferably a Group 4 to 6 transition metal, suitably Ti, Zr or Hf, has a coordination ligand other than a cyclopentadienyl ligand.

The term “non-metallocene” used herein means compounds, which bear no cyclopentadienyl ligands or fused derivatives thereof, but one or more non-cyclopentadienyl n-, or o-, mono-, bi- or multidentate ligand. Such ligands can be chosen e.g. from the groups (b) and (c) as defined above and described e.g. in WO 01/70395, WO 97/10248, WO 99/41290, and WO 99/10353), and further in V. C. Gibson et al., in Angew. Chem. Int. Ed., engl., vol 38, 1999, pp 428 447, the disclosures of which are incorporated herein by reference.

However, the organometallic compound (C) of the present invention is preferably a metallocene as defined above.

Metallocenes are described in numerous patents. In the following just a few examples are listed; EP 260 130, WO 97/28170, WO 98/46616, WO 98/49208, WO 98/040331, WO 99/12981, WO 99/19335, WO 98/56831, WO 00/34341, WO00/148034, EP 423 101, EP 537 130, WO2002/02576, WO2005/105863, WO 2006097497, WO2007/116034, WO2007/107448, WO2009/027075, WO2009/054832, WO 2012/001052, and EP 2532687, the disclosures of which are incorporated herein by reference. Further, metallocenes are described widely in academic and scientific articles.

In a preferred embodiment the organometallic compound (C) has the following formula (Ia):

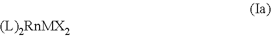

wherein
“M” is Zr or Hf;
each “X” is a σ-ligand;
each “L” is an optionally substituted cyclopentadienyl, indenyl or tetrahydroindenyl;
“R” is SiMe₂ bridging group linking said organic ligands (L);
“n” is 0 or 1, preferably 1.

The metallocene catalyst complexes of the invention are preferably asymmetrical. Asymmetrical means simply that the two ligands forming the metallocene are different, that is, each ligand bears a set of substituents that are chemically different.

The metallocene catalyst complexes of the invention are typically chiral, racemic bridged bisindenyl C₁-symmetric metallocenes in their anti-configuration. Although such complexes are formally C₁-symmetric, the complexes ideally retain a pseudo-C₂-symmetry since they maintain C₂-symmetry in close proximity of the metal center although not at the ligand periphery. By nature of their chemistry both anti and syn enantiomer pairs (in case of C₁-symmetric complexes) are formed during the synthesis of the complexes. For the purpose of this invention, racemic-anti means that the two indenyl ligands are oriented in opposite directions with respect to the cyclopentadienyl-metal-cyclopentadienyl plane, while racemic-syn means that the two indenyl ligands are oriented in the same direction with respect to the cyclopentadienyl-metal-cyclopentadienyl plane, as shown in the scheme below.

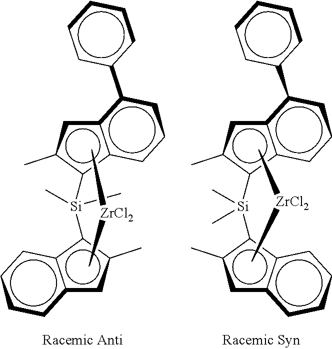

Formula (I), and any sub formulae, are intended to cover both syn- and anti-configurations. Preferred metallocene catalyst complexes are in the anti configuration.

The metallocene catalyst complexes of the invention are generally employed as the racemic-anti isomers. Ideally, therefore at least 95% mol, such as at least 98% mol, especially at least 99% mol of the metallocene catalyst complex is in the racemic-anti isomeric form.

More preferably, the metallocene catalyst is of formula (II)

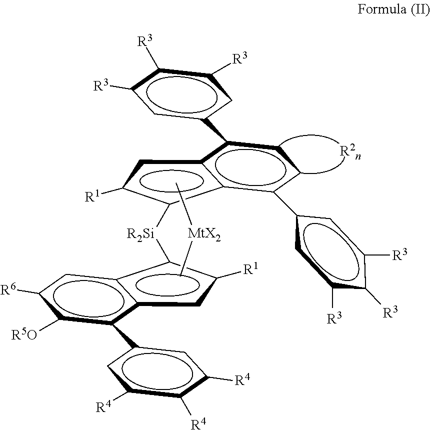

Mt is Hf or Zr;
each X is a sigma-ligand;
each R¹ independently are the same or can be different and are a CH₂—R⁷ group, with R⁷ being H or linear or branched C₁₋₆-alkyl group, C₃₋₈ cycloalkyl group, C₆₋₁₀ aryl group,
each R² is independently a —CH═, —CY═, —CH₂—, —CHY— or —CY₂— group, wherein Y is a C₁₋₁₀ hydrocarbyl group and where n is 2-6,
each R³ and R⁴ are independently the same or can be different and are hydrogen, a linear or branched C₁-C₆-alkyl group, an OY group or a C₇₋₂₀ arylalkyl, C₇₋₂₀ alkylaryl group or C₆₋₂₀ aryl group, whereby at least one R³ per phenyl group and at least one R⁴ is not hydrogen, and optionally two adjacent R³ or R⁴ groups can be part of a ring including the phenyl carbons to which they are bonded,
R⁵ is a linear or branched C₁-C₆-alkyl group, C₇₋₂₀ arylalkyl, C₇₋₂₀ alkylaryl group or C₆-C₂₀-aryl group,
R⁶ is a C(R⁸)₃ group, with R⁸ being a linear or branched C₁-C₆alkyl group, and each R is independently a C₁-C₂₀-hydrocarbyl.

It is preferred if Mt is Zr.

Preferably, each X is independently a hydrogen atom, a halogen atom, C₁₋₆ alkoxy group or an R′ group, where R′ is a C₁₋₆ alkyl, phenyl or benzyl group. Most preferably, X is chlorine, benzyl or a methyl group. Preferably, both X groups are the same. The most preferred options are two chlorides, two methyl or two benzyl groups, especially two chlorides.

Each R is independently a C₁-C₂₀-hydrocarbyl, such as C₆-C₂₀-aryl, C₇-C₂₀-arylalkyl or C₇-C₂₀-alkylaryl. The term C₁₋₂₀ hydrocarbyl group also includes C₁₋₂₀ alkyl, C₂₋₂₀ alkenyl, C₂₋₂₀ alkynyl, C₃₋₂₀ cycloalkyl, C₃₋₂₀ cycloalkenyl, C₆₋₂₀ aryl groups, C₇₋₂₀ alkylaryl groups or C₇₋₂₀ arylalkyl groups or mixtures of these groups such as cycloalkyl substituted by alkyl. Unless otherwise stated, preferred C₁₋₂₀ hydrocarbyl groups are C₁₋₂₀ alkyl, C₄₋₂₀ cycloalkyl, C₆₋₂₀ cycloalkyl-alkyl groups, C₇₋₂₀ alkylaryl groups, C₇₋₂₀ arylalkyl groups or C₆₋₂₀ aryl groups.

Preferably, both R groups are the same. It is preferred if R is a C₁-C₁₀-hydrocarbyl or C₆-C₁₀-aryl group, such as methyl, ethyl, propyl, isopropyl, tertbutyl, isobutyl, C₅₋₆-cycloalkyl, cyclohexylmethyl, phenyl or benzyl, more preferably both R are a C₁-C₆-alkyl, C₃₋₈ cycloalkyl or C₆-aryl group, such as a C₁-C₄-alkyl, C5-6 cycloalkyl or C₆-aryl group and most preferably both R are methyl or one is methyl and another cyclohexyl. Most preferably the bridge is —Si(CH₃)₂—.

Each R¹ independently are the same or can be different and are a CH₂—R⁷ group, with R⁷ being H or linear or branched C₁₋₆-alkyl group, like methyl, ethyl, n-propyl, i-propyl, n-butyl, i-butyl, sec-butyl and tert.-butyl or C₃₋₈ cycloalkyl group (e.g. cyclohexyl), C₆₋₁₀ aryl group (preferably phenyl).

Preferably, both R¹ groups are the same and are a CH₂—R⁷ group, with R⁷ being H or linear or branched C₁-C₄-alkyl group, more preferably, both R¹ groups are the same and are a CH₂—R⁷ group, with R⁷ being H or linear or branched C₁-C₃-alkyl group. Most preferably, both R¹ are both methyl.

Each R² is independently a —CH═— —CY═, —CH₂—, —CHY— or —CY₂— group, wherein Y is a C₁₋₁₀ hydrocarbyl group, preferably a C₁₋₄ hydrocarbyl group and where n is 2-6, preferably 3-4.

Each substituent R³ and R⁴ are independently the same or can be different and are hydrogen, a linear or branched C₁-C₆-alkyl group, an OY group or a C₇₋₂₀ arylalkyl, C₇₋₂₀ alkylaryl group or C₆₋₂₀ aryl group, preferably hydrogen, a linear or branched C₁-C₆-alkyl group or C₆₋₂₀ aryl groups, and optionally two adjacent R³ or R⁴ groups can be part of a ring including the phenyl carbons to which they are bonded. More preferably, R³ and R⁴ are hydrogen or a linear or branched C₁-C₄ alkyl group or a OY-group, wherein Y is a is a C₁₋₄ hydrocarbyl group. Even more preferably, each R³ and R⁴ are independently hydrogen, methyl, ethyl, isopropyl, tert-butyl or methoxy, especially hydrogen, methyl or tert-butyl, whereby at least one R³ per phenyl group and at least one R⁴ is not hydrogen.

Thus, preferably one or two R³ per phenyl group are not hydrogen, more preferably on both phenyl groups the R³ groups are the same, like 3′,5′-di-methyl or 4′-tert-butyl for both phenyl groups.

For the indenyl moiety preferably one or two R⁴ on the phenyl group are not hydrogen, more preferably two R⁴ are not hydrogen and most preferably these two R⁴ are the same like 3′,5′-di-methyl or 3′,5′-di-tert-butyl.

R⁵ is a linear or branched C₁-C₆-alkyl group such as methyl, ethyl, n-propyl, i-propyl, n-butyl, i-butyl, sec-butyl and tert-butyl, C₇₋₂₀ arylalkyl, C₇₋₂₀ alkylaryl group or C₆-C₂₀ aryl group. R⁵ is a preferably a linear or branched C₁-C₆ alkyl group or C₆₋₂₀ aryl group, more preferably a linear C₁-C₄ alkyl group, even more preferably a C₁-C₂ alkyl group and most preferably methyl.

R⁶ is a C(R⁸)₃ group, with R⁸ being a linear or branched C₁-C₆ alkyl group. Each R is independently a C₁-C₂₀-hydrocarbyl, C₆-C₂₀-aryl, C₇-C₂₀-arylalkyl or C₇-C₂₀-alkylaryl. Preferably each R⁸ are the same or different with R⁸ being a linear or branched C₁-C₄-alkyl group, more preferably with R⁸ being the same and being a C₁-C₂-alkyl group. Most preferably, all R⁸ groups are methyl.

In a further preferred embodiment the organometallic compound (C) has the following formula (III):

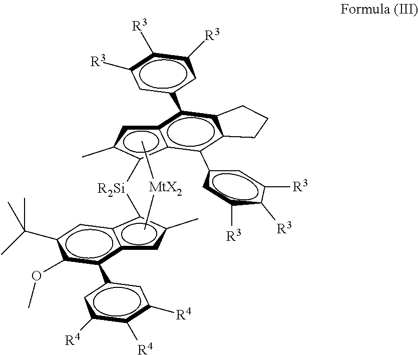

wherein
Mt is Zr or Hf, preferably Zr;
each R³ and R⁴ are independently the same or can be different and are hydrogen or a linear or branched C₁-C₆-alkyl group, whereby at least on R³ per phenyl group and at least one R⁴ is not hydrogen.

Specific metallocene catalyst complexes include: rac-anti-dimethylsilanediyl[2-methyl-4,8-bis-(4′-tert-butylphenyl)-1,5,6,7-tetrahydro-s-indacen-1-yl][2-methyl-4-(3′,5′-dimethyl-phenyl)-5-methoxy-6-tert-butylinden-1-yl]zirconium dichloride; rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl]zirconium dichloride;

rac-anti-dimethylsilanediyl[2-methyl-4,8-bis-(3′,5′-dimethylphenyl)-1,5,6,7-tetrahydro-s-indacen-1-yl][2-methyl-4-(3′,5′-ditert-butyl-phenyl)-5-methoxy-6-tert-butylinden-1-yl] zirconium dichloride or their corresponding zirconium dimethyl analogues.

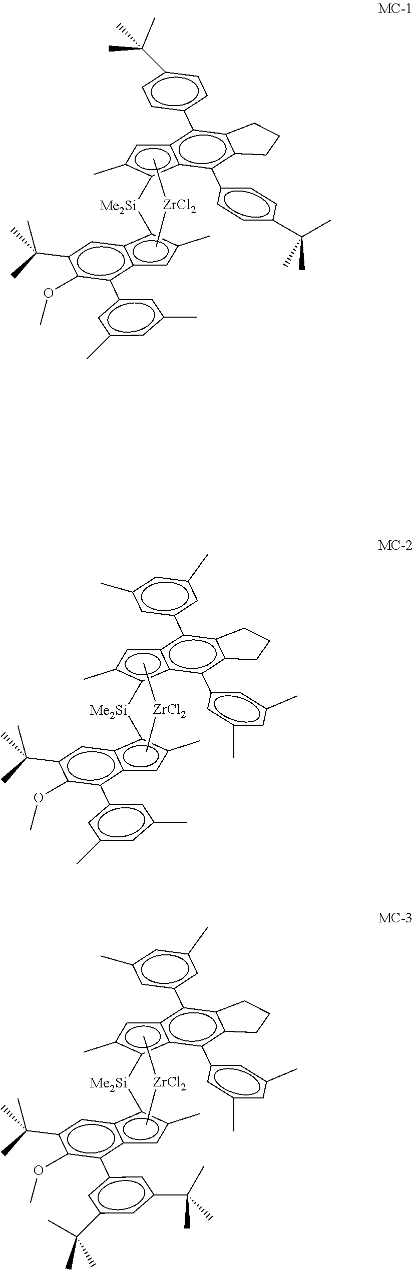

The ligands required to form the metallocene catalysts of the invention can be synthesized by any process and the skilled organic chemist would be able to devise various synthetic protocols for the manufacture of the necessary ligand materials. WO2007/116034, for example, discloses the necessary chemistry. Synthetic protocols can also generally be found in WO2002/02576, WO2011/135004, WO2012/084961, WO2012/001052, WO2011/076780 and WO2015/158790.

To form an active catalytic species it is normally necessary to employ a cocatalyst as is well known in the art.

According to the present invention a cocatalyst system comprising a boron containing cocatalyst and/or an aluminoxane cocatalyst is used in combination with the above defined metallocene catalyst.

The aluminoxane cocatalyst can be one of formula (IV):

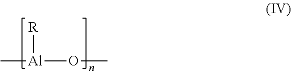

where n is usually from 6 to 20 and R has the meaning below.

Aluminoxanes are formed on partial hydrolysis of organoaluminum compounds, for example those of the formula AlR₃, AlR₂Y and Al₂R₃Y₃ where R can be, for example, C₁-C₁₀ alkyl, preferably C₁-C₅ alkyl, or C₃-C₁₀ cycloalkyl, C₇-C₁₂ arylalkyl or alkylaryl and/or phenyl or naphthyl, and where Y can be hydrogen, halogen, preferably chlorine or bromine, or C₁-C₁₀ alkoxy, preferably methoxy or ethoxy. The resulting oxygen-containing aluminoxanes are not in general pure compounds but mixtures of oligomers of the formula (III).

The preferred aluminoxane is methylaluminoxane (MAO). Since the aluminoxanes used according to the invention as cocatalysts are not, owing to their mode of preparation, pure compounds, the molarity of aluminoxane solutions hereinafter is based on their aluminium content.

According to the present invention, also a boron containing cocatalyst can be used instead of the aluminoxane cocatalyst or the aluminoxane cocatalyst can be used in combination with a boron containing cocatalyst.

It will be appreciated by the person skilled in the art that where boron based cocatalysts are employed, it is normal to pre-alkylate the complex by reaction thereof with an aluminium alkyl compound, such as TIBA. This procedure is well known and any suitable aluminium alkyl, e.g. Al(C₁-C₆ alkyl)₃ can be used. Preferred aluminium alkyl compounds are triethylaluminium, tri-isobutylaluminium, tri-isohexylaluminium, tri-n-octylaluminium and tri-isooctylaluminium.

Alternatively, when a borate cocatalyst is used, the metallocene complex is in its alkylated version, that is for example a dimethyl or dibenzyl metallocene complex can be used.

Boron based cocatalysts of interest include those of formula (V)

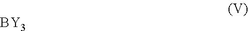

wherein Y is the same or different and is a hydrogen atom, an alkyl group of from 1 to about carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are methyl, propyl, isopropyl, isobutyl or trifluoromethyl, unsaturated groups such as aryl or haloaryl like phenyl, tolyl, benzyl groups, p-fluorophenyl, 3,5-difluorophenyl, pentachlorophenyl, pentafluorophenyl, 3,4,5-trifluorophenyl and 3,5-di(trifluoromethyl)phenyl. Preferred options are trifluoroborane, triphenylborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(tolyl)borane, tris(3,5-dimethyl-phenyl)borane, tris(3,5-difluorophenyl)borane and/or tris(3,4,5-trifluorophenyl)borane.

Particular preference is given to tris(pentafluorophenyl)borane.

However it is preferred that borates are used, i.e. compounds containing a borate 3⁺ ion.

Such ionic cocatalysts preferably contain a non-coordinating anion such as tetrakis(pentafluorophenyl)borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred ionic compounds which can be used according to the present invention include:
triethylammoniumtetra(phenyl)borate,
tributylammoniumtetra(phenyl)borate,
trimethylammoniumtetra(tolyl)borate,
tributylammoniumtetra(tolyl)borate,
tributylammoniumtetra(pentafluorophenyl)borate,
tripropylammoniumtetra(dimethylphenyl)borate,
tributylammoniumtetra(trifluoromethylphenyl)borate,
tributylammoniumtetra(4-fluorophenyl)borate,
N,N-dimethylcyclohexylammoniumtetrakis(pentafluorophenyl)borate,
N, N-dimethylbenzylammoniumtetrakis(pentafluorophenyl)borate,
N,N-dimethylaniliniumtetra(phenyl)borate,
N,N-diethylaniliniumtetra(phenyl)borate,
N,N-dimethylaniliniumtetrakis(pentafluorophenyl)borate,
N,N-di(propyl)ammoniumtetrakis(pentafluorophenyl)borate,
di(cyclohexyl)ammoniumtetrakis(pentafluorophenyl)borate,
triphenylphosphoniumtetrakis(phenyl)borate,
triethylphosphoniumtetrakis(phenyl)borate,
diphenylphosphoniumtetrakis(phenyl)borate,
tri(methylphenyl)phosphoniumtetrakis(phenyl)borate,
tri(dimethylphenyl)phosphoniumtetrakis(phenyl)borate,
triphenylcarbeniumtetrakis(pentafluorophenyl)borate,
or ferroceniumtetrakis(pentafluorophenyl)borate.

Preference is given to triphenylcarbeniumtetrakis(pentafluorophenyl)borate, N,N-dimethylcyclohexylammoniumtetrakis(pentafluorophenyl)borate or N,N-dimethylbenzylammoniumtetrakis(pentafluorophenyl)borate.

It has been surprisingly found that certain boron cocatalysts are especially preferred.

Preferred borates of use in the invention therefore comprise the trityl ion. Thus the use of N,N-dimethylammonium-tetrakispentafluorophenylborate and Ph₃CB(PhF₅)₄ and analogues therefore are especially favoured.

According to the present invention, the preferred cocatalysts are aluminoxanes, more preferably methylaluminoxanes, combinations of aluminoxanes with Al-alkyls, boron or borate cocatalysts, and combination of aluminoxanes with boron-based cocatalysts.

Suitable amounts of cocatalyst will be well known to the person skilled in the art.

The molar ratio of boron to the metal ion of the metallocene may be in the range 0.5:1 to 10:1 mol/mol, preferably 1:1 to 10:1 mol/mol, especially 1:1 to 5:1 mol/mol.

The molar ratio of Al in the aluminoxane to the metal ion of the metallocene may be in the range 1:1 to 2000:1 mol/mol, preferably 10:1 to 1000:1 mol/mol, and more preferably 50:1 to 900:1 mol/mol, and most preferably 600:1 to 800:1 mol/mol.

The metallocene catalyst used in the polymerisation process of the present invention is used in supported form. The support used comprises, preferably consists of, silica. The person skilled in the art is aware of the procedures required to support a metallocene catalyst.

Especially preferably, the support is a porous material so that the complex may be loaded into the pores of the support, e.g. using a process analogous to those described in WO 94/14856 (Mobil), WO 95/12622 (Borealis) and WO 2006/097497.

The average particle size of the support can be typically from 10 to 100 μm. However, it has turned out that special advantages can be obtained if the support has an average particle size from 15 to 80 μm, preferably from 18 to 50 μm.

The particle size distribution of the support is described in the following. The support preferably has a D₅₀ of between 10 and 80 μm, preferably 18 and 50 μm. Furthermore, the support preferably has a D₁₀ of between 5 and 30 μm and a D₉₀ of between 30 and 90 μm. Preferably, the support has a SPAN value of 0.1 to 1.1, preferably 0.3 to 1.0.

The average particle size of the metallocene catalyst is preferably of from 20 to 50 μm, more preferably of from 25 to 45 μm, and most preferably of from 30 to 40 μm.

The particle size distribution of the metallocene catalyst is described in the following. The metallocene catalyst preferably has a D50 of from 30 to 80 μm, preferably of from 32 to 50 μm and most preferably of from 34 to 40 μm. Furthermore, the metallocene catalyst preferably has a D10 of at most 29 μm, more preferably of from 15 to 29 μm, more preferably of from 20 to 28 μm, and most preferably of from 25 to 27 μm. The metallocene catalyst preferably has a D90 of at least 45 μm, more preferably of from 45 to 70 μm and most preferably of from 40 to 60 μm.

The average pore size of the support can be in the range 10 to 100 nm, preferably 20 to 50 nm and the pore volume from 1 to 3 ml/g, preferably 1.5 to 2.5 ml/g. BET surface area of silica support materials are determined according to ASTM D3663 and porosity parameters based on BJH according to ASTM D4641. Examples of suitable support materials are, for instance, ES757 produced and marketed by PQ Corporation, Sylopol 948 produced and marketed by Grace or SUNSPERA DM-L-303 silica produced by AGC Si-Tech Co.

Supports can be optionally calcined prior to the use in catalyst preparation in order to reach optimal silanol group content.

All or part of the preparation steps can be done in a continuous manner. The formed catalyst preferably has good stability/kinetics in terms of longevity of reaction, high activity and the catalysts enable low ash contents.

Generally, silica supported polymerisation catalysts show very complex polymerisation behaviour and the polymerisation process can be subdivided into several phases.

During the first minutes of polymerization, the catalyst activity can reach high values resulting in an uncontrollable fragmentation process which in turn can lead to decrease of catalyst activity due to increased external mass and heat transport phenomena. More particularly, the exothermic heat generated due to the polymerisation reaction cannot be properly dissipated, thus, leading to local particle overheating (i.e., the temperature difference between the surface of the growing polymer particles and the bulk temperature attains high values). Therefore, the polymer that is produced on the surface of the growing polymer particle becomes sticky, thus leading to increased risk of particle agglomeration, with concomitant effects on process performance and reactor operability.

A polymerisation kinetic described above requires a new design of the prepolymerisation process with respect to temperature, monomer concentration and residence time.

In a preferred embodiment of the invention, in the initial phase (first activity peak) the temperature and monomer concentration must be as low as possible to avoid overheating of the formed polymer and to avoid formation of agglomerates. In the second phase the monomer concentration and the temperature must be as high as possible to accelerate the catalyst fragmentation process.

In one embodiment, the polymerisation is carried out in the presence of hydrogen. Hydrogen is typically employed to help control polymer properties, such as polymer molecular weight. In an alternative embodiment, hydrogen is not added in step a) or c). The skilled worker will appreciate, however, that hydrogen may be generated during the polymerisation process. Thus, the hydrogen present in the polymerisation reaction mixture formed in step a) or c) of the process may originate from hydrogen which has been added as a reactant and/or hydrogen produced as a side product during polymerisation.

According to the present invention, step a) is a prepolymerisation step. The purpose of the prepolymerisation is to polymerise a small amount of polymer onto the catalyst at a low temperature and/or a low monomer concentration. By prepolymerisation it is possible to improve the performance of the catalyst in slurry and/or modify the properties of the final polymer. The prepolymerisation step is typically conducted as slurry polymerization. Use of the catalyst prepolymerisation step offers the advantage of minimizing leaching of catalyst components.

In step c) of the present invention a lower catalyst activity helps in controlling the polymerization reaction more accurately, allowing an easier fine tuning the process parameters and hence operating closer to the ideal conditions. Otherwise, for a high catalyst activity, the reaction is more difficult to control and the flexibility in adjusting the operating conditions is reduced.

The slurry polymerization in step a) is preferably a bulk polymerization. By “bulk polymerization” a process is meant wherein the polymerization is conducted in a liquid monomer essentially in the absence of an inert diluent. However, as it is known to a person skilled in the art the monomers used in commercial production are never pure but always contain aliphatic hydrocarbons as impurities. For instance, the propylene monomer may contain up to 5% of propane as an impurity. As propylene is consumed in the reaction and also recycled from the reaction effluent back to the polymerization, the inert components tend to accumulate, and thus the reaction medium may comprise up to 40 wt. % of other compounds than monomer. It is to be understood, however, that such a polymerization process is still within the meaning of “bulk polymerization”, as defined above.

The slurry polymerisation, preferably the bulk polymerization, may be conducted in any known reactor used for slurry polymerisation. Such reactors include a continuous stirred tank reactor and a loop reactor. It is especially preferred to conduct the polymerisation in a loop reactor.

Preferably, the first reactor is a loop reactor. In such reactors, the slurry is circulated with a high velocity along a closed pipe by using a circulation pump. Loop reactors are generally known in the art and examples are given, for instance, in U.S. Pat. Nos. 4,582,816, 3,405,109, 3,324,093, EP-A-479186 and U.S. Pat. No. 5,391,654. It is thus preferred to conduct the first polymerisation stage as a slurry polymerisation in a loop reactor.

The amount of monomer is typically such that from 0.1 to 1000 g of monomer per one gram of solid catalyst component is polymerised in the prepolymerisation step. As the person skilled in the art knows, the catalyst particles recovered from a continuous prepolymerisation reactor do not all contain the same amount of prepolymer. Instead, each particle has its own characteristic amount, which depends on the residence time of that particle in the prepolymerisation reactor. As some particles remain in the reactor for a relatively long time and some for a relatively short time, then also the amount of prepolymer on different particles is different and some individual particles may contain an amount of prepolymer which is outside the above limits. However, the average amount of prepolymer on the catalyst typically is within the limits specified above.

The molecular weight of the prepolymer may be controlled by hydrogen as it is known in the art. Further, antistatic additives may be used to prevent the particles from adhering to each other or the walls of the reactor, as disclosed in WO-A-96/19503 and WO-A-96/32420.

It is understood within the scope of the invention, that the amount of polymer produced in the prepolymerisation typically lies within 1.0-5.0 wt. % in respect to the polypropylene copolymer.

Preferably, the temperature in the first reactor is between 10 and 40° C., more preferably between 1° and 30° C., most preferably between 15 and 25° C.

Preferably, the pressure in the first reactor is preferably from 1 to 150 bar, more preferably 35 to 60 bar, even more preferably 40 to 55 bar, and most preferably 43 to 52 bar.

In step a) the ratio of the feed of ethylene to the feed of propylene is preferably in the range from 1 to 14 mol/kmol, more preferably in the range from 2 to 13 mol/kmol.

The average residence time in the first reactor in step a) is typically from 0.05 to 0.5 h, preferably from 0.1 to 0.4 h, more preferably from 0.2 to 0.3 h. As it is well known in the art the average residence time τ can be calculated from equation (1) below:

$$τ = \frac{{V}_{R}}{{Q}_{o}} \qquad equation ( 1 )$$

wherein
V_{R} is the volume of the reaction space (in case of a loop reactor, the volume of the reactor, in case of the fluidized bed reactor, the volume of the fluidized bed)
Qₒ is the volumetric flow rate of the product stream (including the polymer product and the fluid reaction mixture).

As used herein, the production rate of the polypropylene produced (kg PP/h) is measured for the first or second reactor, respectively, by their respective energy balance. Typically production rates in the first reactor are 0.5 to 2.0 kg PP/h.

The prepolymerisation degree in the first reactor is calculated by diving the production rate in the first reactor by the catalyst feed to the first reactor. The catalyst feed in the first reactor is typically 1.0 to 4.0 g catalyst/h or preferably 2.0 to 4.6 g catalyst/h or. As a result the prepolymerisation degree is typically and preferably of from 50 to 2000 g PP/g catalyst, more preferably more than 510 to 1000 g PP/g catalyst and most preferably more than 520 to 700 g PP/g catalyst.

In step b) the prepolymer obtained in step a) is transferred to a second reactor, preferably directly transferred to a second reactor. Preferably, the prepolymer is transferred to the second reactor in the form of a slurry. The slurry preferably comprises the prepolymer, unreacted monomer and the metallocene catalyst.

The slurry may be withdrawn from the first reactor either continuously or intermittently. A preferred way of intermittent withdrawal is the use of settling legs where slurry is allowed to concentrate before withdrawing a batch of the concentrated slurry from the reactor. The use of settling legs is disclosed, among others, in U.S. Pat. Nos. 3,374,211, 3,242,150 and EP-A-1310295. Continuous withdrawal is disclosed, among others, in EP-A-891990, EP-A-1415999, EP-A-1591460 and WO-A-2007/025640. The continuous withdrawal is advantageously combined with a suitable concentration method, as disclosed in EP-A-1310295 and EP-A-1591460. It is preferred to withdraw the slurry from the first reactor continuously.

Preferably, the slurry withdrawn from the first reactor is directly transferred into the second reactor to produce the polypropylene copolymer. By “directly” it is meant that the slurry is introduced from the first reactor into the second reactor without any separation step in between.

Similar to step a), step c) in the second reactor is conducted as a slurry polymerisation, the slurry polymerisation preferably being a bulk polymerisation. Preferably, the second reactor is a loop reactor.

Preferably, the temperature in step c) is in the range of 60 to 100° C., more preferably 65 to 90° C., most preferably 70 to 85° C. Respectively, step c) is preferably carried out at a pressure in the range of 1 to 100 bar, more preferably 20 to 80 bar, more preferably 30 to 70 bar.

Preferably, the metallocene catalyst used in step a) is present in the second reactor during the polymerisation in step c). This is accomplished by transferring, preferably via the slurry, the metallocene catalyst used in step a) into the second reactor. If needed, fresh metallocene catalyst may be added into the second reactor in step c).

In step c) the ratio of the feed of comonomer to the feed of propylene is preferably in the range of 1 to 15 mol/kmol, preferably 1.5 to 10 mol/kmol, and more preferably 2 to 9 mol/kmol.

In step c), the one or more comonomers are selected from alpha olefins having from 2 or 4 to 10 carbon atoms or mixtures thereof. Preferably, the one or more comonomers are alpha olefins having 2 or 4 carbon atoms, i.e. ethylene or 1-butene, and most preferably having 2 carbon atoms, i.e. ethylene.

Hydrogen is typically introduced into the polymerisation stage in step c) for controlling the MFR₂ of the propylene copolymer. The amount of hydrogen needed to reach the desired MFR₂ depends on the catalyst used and the polymerisation conditions, as will be appreciated by the skilled worker.

The average residence time in the polymerisation stage in step c) is typically from 20 to 120 min, preferably from 30 to 80 min. Reference is made to equation (1) above.

The production rate is suitably controlled with the catalyst feed rate. It is also possible to influence the production rate by suitable selection of the monomer concentration. The desired monomer concentration can then be achieved by suitably adjusting the propylene feed rate.

It will be appreciated that the propylene polymers may contain standard polymer additives. These typically form less than 5.0 wt. %, such as less than 2.0 wt. % of the polymer material. Additives, such as antioxidants, phosphites, cling additives, pigments, colorants, fillers, anti-static agent, processing aids, clarifiers and the like may thus be added during the polymerisation process. These additives are well known in the industry and their use will be familiar to the artisan. Any additives which are present may be added as an isolated raw material or in a mixture with a carrier polymer, i.e. in so called master batch.

In a further preferred embodiment of the invention, the polymerisation process does not comprise a step of recovering the comonomer.

The production split between the prepolymer of step a) and the polypropylene copolymer of step c) is preferably in the range of from 0.1 to 10 wt. %, more preferably of from 0.5 to 5 wt. %, and most preferably of from 1 to 3 wt. %.

In step d) the polypropylene copolymer obtained in step c) is either withdrawn from the second reactor or transferred to a third reactor, preferably the polypropylene copolymer obtained in step c) is transferred to a third reactor.

Preferably, the third reactor is a gas phase reactor, more preferably a fluidized bed gas phase reactor.

Preferably, the third reactor is a gas phase reactor, more preferably a fluidized bed gas phase reactor. Any suitable gas phase reactor known in the art may be used, such as a fluidized bed gas phase reactor.

For gas phase reactors, the reaction temperature used will generally be in the range 65 to 90° C., the reactor pressure will generally be in the range 10 to 40 bar. The gas used will commonly be a non-reactive gas such as nitrogen or low boiling point hydrocarbons such as propane together with monomer (e.g. ethylene). Preferably, the temperature is in the range of 65 to 90° C., more preferably 70 to 85° C. Preferably, the pressure is in the range of 15 to 26 bar, more preferably 20 to 25 bar.

Also, the residence time and/or the one or more comonomers present in the third reactor are preferably the same as described for the second reactor above.

In the process according to the invention, not only a first reactor as prepolymerisation reactor and a subsequent second reactor can be used. Preferably, the process of the invention further comprises a third reactor downstream of the second reactor, more preferably a third reactor downstream of the second reactor and a fourth reactor downstream of the third reactor, and most preferably a third reactor downstream of the second reactor, a fourth reactor downstream of the third reactor and a fifth reactor downstream of the fourth reactor, for further polymerisation.

The fourth reactor and/or the fifth reactor are preferably a gas phase reactor, more preferably a fluidized bed gas phase reactor. The temperature and pressure in the fourth reactor and/or the fifth reactor are preferably the same as described for the third reactor above. Also, the residence time and/or the one or more comonomers present in the fourth reactor and/or the fifth reactor are preferably the same as described for the third reactor above.

A suitable process is the above-identified slurry-gas phase process, such as developed by Borealis and known as the Borstar® technology. In this respect, reference is made to the EP applications EP 0 887 379 A1 and EP 0 517 868 A1.

### EXPERIMENTAL PART

### Measurement Methods

Any parameter mentioned above in the detailed description of the invention is measured according to the tests given below.

### a) Melt Flow Rate

The melt flow rate (MFR) is determined according to ISO 1133 and is indicated in g/10 min. The MFR is an indication of the melt viscosity of the polymer. The MFR is determined at 190° C. for PE and 230° C. for PP. The load under which the melt flow rate is determined is usually indicated as a subscript, for instance MFR₂ is measured under 2.16 kg load (condition D).

### b) Particle Size and Particle Size Distribution

The particle size distribution was determined using laser diffraction measurements by Coulter LS 200. The particle size and particle size distribution is a measure for the size of the particles. The D-values (D10 (or d10), D50 (or d50) and D90 (or d90)) represent the intercepts for 10%, 50% and 90% of the cumulative mass of sample. The D-values can be thought of as the diameter of the sphere which divides the sample's mass into a specified percentage when the particles are arranged on an ascending mass basis. For example the D10 is the diameter at which 10% of the sample's mass is comprised of particles with a diameter less than this value. The D50 is the diameter of the particle where 50% of a sample's mass is smaller than and 50% of a sample's mass is larger than this value. The D90 is the diameter at which 90% of the sample's mass is comprised of particles with a diameter less than this value. The D50 value is also called median particle size. From laser diffraction measurements according to ISO 13320 the volumetric D-values are obtained, based on the volume distribution.
The distribution width or span of the particle size distribution is calculated from the D-values D10, D50 and D90 according to equation (3):

$$Span = ( D 90 - D 10 ) / D 50 \qquad equation ( 3 )$$

Sieve fraction is determined by a Camsizer P4 from the Company Retsch Technology GmbH via digital image analysis. The measuring principle is a dynamic image analysis according to ISO 13322-2.

### c) Density

Density of the polymer was measured according to ISO 1183/1872-2B. For the purpose of this invention the density of the blend can be calculated from the densities of the components according to:

$${ρ}_{b} = {\sum }_{i} {w}_{i} \cdot {ρ}_{i}$$

where
   ρ_{b} is the density of the blend,
   wᵢ is the weight fraction of component ‘i’ in the blend and
   ρᵢ is the density of the component ‘i’.

### d) Differential Scanning Calorimetry (DSC)

Differential scanning calorimetry (DSC) analysis, melting temperature (Tₘ) and melt enthalpy (Hₘ), crystallization temperature (T_{c}), and heat of crystallization (H_{c}, H_{cr}) are measured with a TA Instrument Q200 differential scanning calorimetry (DSC) on 5 to 7 mg samples. DSC is run according to ISO 11357/part 3/method C2 in a heat/cool/heat cycle with a scan rate of 10° C./min in the temperature range of −30 to +225° C.
Crystallization temperature (T_{c}) and heat of crystallization (H_{c}) are determined from the cooling step, while melting temperature (Tₘ) and melt enthalpy (Hₘ) are determined from the second heating step.
Throughout the patent the term T_{c} or (T_{cr}) is understood as Peak temperature of crystallization as determined by DSC at a cooling rate of 10 K/min (i.e. 0.16 K/sec).

### e) Quantification of Microstructure by NMR Spectroscopy

Quantitative nuclear-magnetic resonance (NMR) spectroscopy was used to quantify the comonomer content of the polymers, comonomer dyad sequence distribution and sequence order parameter quantification.
Quantitative ¹³C{¹H} NMR spectra were recorded in the solution-state using a Bruker Avance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 7,2-tetrachloroethane-d/2 (TCE-d/2) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1 128). A total of 6144 (6 k) transients were acquired per spectra.

### Comonomer Content Quantification of Poly(Propylene-Co-Ethylene) Copolymers

Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed (Cheng, H. N., Macromolecules 17 (1984), 1950) and the comonomer fractions calculated as the fraction of ethylene and propylene in the polymer with respect to all monomer in the polymer:
The comonomer fraction was quantified using the method of Wang et. al. (Wang, W-J., Zhu, S., Macromolecules 33 (2000), 1157) through integration of multiple signals across the whole spectral region in the ¹³C{¹H} spectra. This method was chosen for its robust nature and ability to account for the presence of regio-defects when needed.
The mole percent comonomer incorporation was calculated from the mole fraction:

$$E [ mol \% ] = 100 * fE$$

The weight percent comonomer incorporation was calculated from the mole fraction:

$$E [ wt . - \% ] = 100 * ( fE * 28.06 ) / ( ( fE * 28.06 ) + ( ( 1 - fE ) * 42.08 ) )$$

### Comonomer Dyad Sequences Determination

Comonomer sequence distribution was quantified at the dyad level using the characteristic signals corresponding to the incorporation of ethylene into propylene-ethylene copolymers (Cheng, H. N., Macromolecules 17 (1984), 1950). Integrals of respective sites were taken individually, the regions of integration described in the article of Wang et. al. were not applied for dyad sequence quantification.
It should be noted that due to overlapping of the signals of Tβδ and Sγγ, the compensation equations were applied for integration range of these signals using the sites Sβδ and Sγδ:

$$S γγ = ( I ( S βδ ) - I ( S γδ ) ) / 2$$

$$T βδ = I ( T βδ + S γγ ) - ( I ( S βδ ) - I ( S γδ ) ) / 2$$

With characteristic signals corresponding to regio defects observed (Resconi, L, Cavallo, L, Fait, A., Piemontesi, F., Chem. Rev. 2000, 100, 1253; Cheng, H. N., Macromolecules 17 (1984), 1950; Wang, W-J., Zhu, S., Macromolecules 33 (2000), 1157) the correction for the influence of the regio defects on comonomer contents was required.
In case of 2,1-erythro mis-insertions presence the signal from ninth carbon (S2ie 9) of this microstructure element (Resconi, L., Cavallo, L., Fait, A., Piemontesi, F., Chem. Rev. 2000, 100, 1253) was chosen for compensation.
In case of 2,1 regio irregular propene units in structure with one successive ethylene units presence, the signal from Tγγ (Cheng, H. N., Macromolecules 17 (1984), 1950; Wang, W-J., Zhu, S., Macromolecules 33 (2000), 1157) was chosen for compensation. The constitutive equations were:

$$EP = 2 * T δδ + T βδ + 2 * T γγ = 2 * I ( T δδ ) + I ( T βγ + S γγ ) - ( I ( S βδ ) - I ( S γδ ) ) / 2 + 2 * I ( T γγ )$$

$$EE = S γγ + S γδ + ( S δδ - S γδ / 2 ) / 2 = 0.5 * I ( S βγ ) + 0.5 * I ( S δδ ) + 0.25 * I ( S γδ )$$

$$PP = T βδ / 2 + T ββ b + 3 * {S}_{21 e 9} + 2 * T γγ = 0.5 ⋆ ( I ( T βδ d + S γγ ) - ( I ( S βδ ) - I ( S γδ ) ) / 2 ) + I ( T β β ) + 2 * I ( T γγ ) + 3 * I ( {S}_{21 e 9} )$$

Note that for simplicity the two indistinguishable reversible PE and EP dyads are termed EP i.e. EP=PE+EP. The mole fraction of each dyad was determined through normalisation to the sum of all dyads.

$$XX = PP + EP + EE$$

$$fPP = PP / XX$$

$$fEP = EP / XX$$

$$fEE = EE / XX$$

### Sequence Order Parameter Description and Quantification

Sequence order parameter, χ as it is defined by Koenig (Koenig92: Spectroscopy of Polymers, Lack. L Koenig. American Chemical Society, Washington, DC 1992) (or “Koenig B-value” as it is named in WO 2010/078479 A1), yields information about whether the distribution of the structures is random, i.e. can be described by Bernoullian statistics, and whether it tends towards an alternating or block distribution. This parameter can be determined by the formula:

B_{Koenig}=fEP/(2*fE*fP) (IV)

### f) Xylene Cold Soluble Fraction

The xylene cold soluble fraction (XCS) is determined according to ISO 16152 at 25° C.

### Materials

The following catalyst was used in the processes according to the comparative and inventive examples as described in Table 1.

A metallocene catalyst as described in WO 2019/179959 A1 was used.

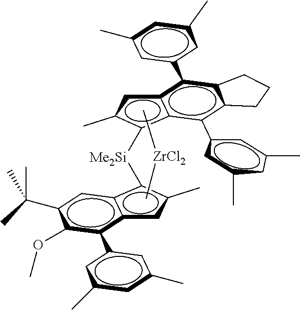

A steel reactor equipped with a mechanical stirrer and a filter net was flushed with nitrogen and the reactor temperature was set to 20° C. Next silica grade DM-L-303 from AGC Si-Tech Co, pre-calcined at 600° C. (10 kg) was added from a feeding drum followed by careful pressuring and depressurising with nitrogen using manual valves. Then toluene (43.5 kg) was added. The mixture was stirred for 30 min. Next 30 wt. % solution of MAO in toluene (17.5 kg) from Lanxess was added via feed line on the top of the reactor within 140 min. The reaction mixture was then heated up to 90° C. and stirred at 90° C. for additional two hours. The slurry was allowed to settle, and the mother liquor was filtered off. The catalyst was washed twice with toluene (43.5 kg) at 90° C., following by settling and filtration.

Finally, MAO treated SiO2 was dried at 60° C. under nitrogen flow for 2 hours and then for 14 hours under vacuum (~0.5 barg) with stirring. MAO treated support was collected as a free-flowing white powder found to contain 15.0% Al by weight. 30 wt. % MAO in toluene (2 kg) was added into a steel nitrogen blanked reactor via a burette at 20° C. Toluene (12.8 kg) was then added under stirring. 129 g of the metallocene was added from a metal cylinder followed by flushing with 1 kg toluene. The mixture was stirred for 60 minutes at 20° C. Trityl tetrakis(pentafluorophenyl)borate (127.2 g) was then added from a metal cylinder followed by a flush with 1 kg of toluene. The mixture was stirred for 1 h at room temperature. The resulting solution was added to a stirred cake of MAO-silica support prepared as described above over 42 hour. The cake was stirred for 30 minutes and then allowed to stay without stirring for 30 minutes, followed by drying under N₂ flow at 60° C. for 2 h and additionally for 15 h under vacuum (~0.5 barg) under stirring.

### EXAMPLES

The following examples were carried out in a pilot plant, comprising a reactor sequence consisting of a prepolymerisation reactor and a loop reactor. Process and properties are given in table 1.

TABLE 1

| Example | | CE1 | IE1 | IE2 | IE3 |
|---|---|---|---|---|---|
| Prepolymerisation reactor | | | | | |
| Temperature | [° C.] | 20 | 20 | 20 | 20 |
| Pressure | [kPa] | 5177 | 5148 | 5135 | 5196 |
| Catalyst feed | [g/h] | 1.9 | 2.2 | 2.2 | 3.5 |
| H2 feed | [g/h] | 0.12 | 0.12 | 0.12 | 0.12 |
| C3 feed | [kg/h] | 65.7 | 65.5 | 65.5 | 65.6 |
| C2 feed | [g/h] | 0 | 90 | 300 | 564 |
| Feed C2/C3 | [mol/kmol] | 0.00 | 2.06 | 6.87 | 12.89 |
| Feed H2/C3 | [mol/kmol] | 0.04 | 0.04 | 0.04 | 0.04 |
| Production rate | [kg/h] | 1.0 | 1.4 | 1.4 | 1.9 |
| Prep-degree | [gPP/g cat] | 504.2 | 635.4 | 628.2 | 537.1 |
| Loop reactor | | | | | |
| Temperature | [° C.] | 75 | 75 | 75 | 75 |
| Pressure | [kPa] | 5054 | 5038 | 5035 | 5098 |
| Feed H2/C3 ratio | [mol/kmol] | 0.4 | 0.4 | 0.4 | 0.4 |
| Feed C2/C3 ratio | [mol/kmol] | 1.2 | 2.4 | 5.0 | 8.2 |
| Production rate | [kg/h] | 29.2 | 31.6 | 29.3 | 30.6 |
| Catalyst activity | [kg/g h⁻¹] | 42.5 | 39.7 | 36.6 | 24.4 |
| Final polymer powder | | | | | |
| MFR₂ | [g/10 min] | 66.60 | 64.20 | 69.90 | 55.80 |
| Total XCS | [wt %] | 0.55 | 0.80 | 0.91 | 1.08 |
| Bulk Density | [kg/m³] | 333.00 | 365.00 | 362.00 | 395.00 |
| Crystallisation temperature | [° C.] | | 119.40 | 119.80 | |
| Melting point | [° C.] | | 155.60 | 154.60 | |
| Sieve bottom | [%] | 0.02 | 0.00 | 0.03 | 0.01 |
| Sieve fraction 0.106 mm | [%] | 0.11 | 0.01 | 0.18 | 0.12 |
| Sieve fraction 0.250 mm | [%] | 0.41 | 0.16 | 0.68 | 0.73 |
| Sieve fraction 0.355 mm | [%] | 8.42 | 14.13 | 19.25 | 17.95 |
| Sieve fraction 0.820 mm | [%] | 77.80 | 76.84 | 72.59 | 71.87 |
| Sieve fraction 2.000 mm | [%] | 13.20 | 8.76 | 7.17 | 9.22 |
| Sieve fraction >4.000 mm | [%] | 0.12 | 0.10 | 0.10 | 0.10 |

As can be seen from the table, the bulk density improved stepwise with the ethylene feed to the prepolymerisation reactor.

1. Process for the production of a polypropylene copolymer, the process comprising the steps of
a) prepolymerising propylene in a first reactor in the presence of ethylene and a metallocene catalyst yielding a prepolymer, wherein a ratio of the feed of ethylene to the feed of propylene is in the range of 0.1 to 15 mol/kmol, and the temperature in the first reactor is between 1° and 40° C.,
b) transferring the prepolymer to a second reactor,
c) polymerising propylene in the second reactor in the presence of said prepolymer and one or more comonomers selected from alpha olefins having from 2 or 4 to 10 carbon atoms or mixtures thereof, yielding a polypropylene copolymer,
d) withdrawing the polypropylene copolymer from the second reactor or transferring the polypropylene copolymer to a third reactor,
wherein the metallocene catalyst comprises a metallocene complex and a support, wherein the support comprises silica.
and wherein the metallocene complex is an organometallic compound (C), the organometallic compound (C) has the following formula (I):
(L)mRnMXq (I)
wherein
“M” is a transition metal (M) transition metal (M) of Group 3 to 10 of the Periodic Table (IUPAC 2007);
each “X” is independently a monoanionic ligand, such as a σ-ligand;
each “L” is independently an organic ligand which coordinates to the transition metal “M”;
“R” is a bridging group linking said organic ligands (L);
“m” is 1, 2 or 3, preferably 2;
“n” is 0, 1 or 2, preferably 1;
“q” is 1, 2 or 3, preferably 2; and
m+q is equal to the valency of the transition metal (M).

2. The process according to claim 1, wherein the support has an average particle size of from 10 to 100 μm as determined according to the specification.

3. The process according to claim 1, wherein the support has an average pore size of from 10 to 100 nm as determined according to the specification.

4. The process according to claim 1, wherein in step a) the ratio of the feed of ethylene to the feed of propylene is in the range of 1 to 14 mol/kmol.

5. The process according to claim 1, wherein the average residence time in the first reactor in step a) is from 0.05 to 0.5 h.

6. The process according to claim 1, wherein in step c) the ratio of the feed of comonomer(s) to the feed of propylene is in the range of 1 to 15 mol/kmol.

7. The process according to claim 1, wherein the comonomer in step c) is ethylene.

8. The process according to claim 1, wherein step a) is carried out as a prepolymerisation step and conducted in slurry.

9. The process according to claim 1, wherein the first reactor is a loop reactor.

10. The process according to claim 1, wherein step c) is conducted as a slurry polymerization and/or the second rector is a loop reactor.

11. The process according to claim 1, wherein in step a) the temperature in the first reactor is between 1° and 40° C. and/or wherein in step a) the pressure in the first reactor is between 1 and 150 bar.

12. The process according to claim 1, wherein in step c) the temperature in the second reactor is between 6° and 90° C., and/or wherein in step c) the pressure in the second reactor is between 1 and 150 bar.

13. The process according to claim 1, wherein in step d) the third reactor is a gas phase reactor.

14. The process according to claim 1, further comprising a fourth reactor downstream of the third reactor.
